(19) United States
(12) Patent Application Publication
(10) Pub. No.: US 2025/0085080 A1
(43) Pub. Date: Mar. 13, 2025

(54) POWER AND DATA RETROFIT FOR WEAPON ACCESSORY RAIL

(71) Applicant: WILCOX INDUSTRIES CORP., Newington, NH (US)

(72) Inventors: James W. Teetzel, Portsmouth, NH (US); Elliott S. Turner, Newmarket, NH (US); Robert Riel, Raymond, NH (US)

(21) Appl. No.: 18/830,125

(22) Filed: Sep. 10, 2024

Related U.S. Application Data
(60) Provisional application No. 63/538,265, filed on Sep. 13, 2023.

(51) Int. Cl. F41C 27/00

(52) U.S. Cl. CPC F41C 27/00

(57) ABSTRACT

An apparatus for providing electrical power and communication of data and control signals to a weapon rail interface includes a controller with a battery adaptor for attaching a power supply. A connector element on the controller allows devices to interface with the controller via a cable connection. Additional devices can be connected in sequential manner via daisy chaining, using inserts chainable together and configured to mechanically attach to slots on a legacy slot rail interface.

### CROSS REFERENCE TO RELATED APPLICATION

This application claims the priority benefit of U.S. provisional application Ser. No. 63/538,265 filed Sep. 13, 2023. The aforementioned application is incorporated herein by reference in its entirety.

### INCORPORATION BY REFERENCE

This application is related to U.S. patent application Ser. No. 18/755,052 filed Jun. 26, 2024, entitled Power and Data Interface for Weapon Accessory Mounting Rail. The entire contents of the aforementioned application including the specification and drawings are incorporated herein by reference in its entirety.

### BACKGROUND

The present invention relates to a weapon mounting system, and more particularly to a retrofit system and method for providing electrical power and data connections on a legacy weapon rail interface.

Advantages and benefits of the present invention will become apparent to those of ordinary skill in the art upon reading and understanding the following detailed description of the preferred embodiments.

### SUMMARY

In one aspect, an apparatus is provided for providing electrical power to and communicating data and control signals among weapon accessory devices disposed on a handguard having a weapon rail interface and a plurality of slots. The apparatus includes a control module attachable to the handguard via at least one of the plurality of slots of the handguard. The control module includes a processor and a power supply operably coupled to the processor. A control module connector element is adapted to extend through the at least one of the plurality of slots via which the control module is attachable to the weapon rail interface. At least one insert includes an insert connector element, the at least one insert adapted for operative coupling with a weapons accessory device, wherein the processor of the control module includes a communications interface for data communication with the at least one insert. At least one cable includes connector ends on either end of the at least one cable, wherein the connector ends are adapted to couple to at least the control module connector element of the control module and the insert connector element of the at least one insert.

In a more limited aspect, the control module further includes a power interface for operably connecting the power supply of the control module.

In another more limited aspect, the at least one cable includes at least two cables and the connector ends are further adapted to couple to the weapons accessory device, wherein the operative coupling of the at least one insert with the weapons accessory device is via one of the at least two cables.

In another more limited aspect, the weapons accessory device with which the at least one insert is adapted for operative coupling is selected from the group consisting of a flashlight, a laser package, an optical sight, and a fire control system.

In another more limited aspect, the apparatus further includes at least one of the weapons accessory devices with which the at least one insert is adapted for operative coupling, wherein the at least one weapons accessory device is one or more selected from the group consisting of a flashlight, a laser package, an optical sight, and a fire control system.

In another more limited aspect, the control module connector element includes connector receptacles that engage with the connector ends of the at least one cable.

In another more limited aspect, the insert connector element includes connector receptacles that engage with the connector ends of the at least one cable.

In another more limited aspect, the at least one insert further includes a housing attached to the insert connector element with at least one electrical contact electrically coupled to connector receptacles for transmitting power and data signals.

In another more limited aspect, the at least one electrical contact is four electrical contacts, a first of which is electrically coupled to the ground/negative terminal of the power supply; a second of which is electrically coupled to a data line that carries positive signals for transmitting data between devices; a third of which is electrically coupled to a data line that carries negative signals for transmitting data between devices; and a fourth of which is electrically coupled to the voltage/positive terminal of the power supply.

In another more limited aspect, the housing has at least one upper peripheral flange.

In another more limited aspect, the at least one upper peripheral flange has a beveled edge.

In another more limited aspect, the at least one insert further includes at least one retention clip with an extending tab portion and a threaded fastener around which the at least one retention clip is rotatable. A channel is defined between the at least one upper peripheral flange and the extending tab portion of the at least one retention clip. Rotation of the retention clip around the threaded fastener allows for tightening and loosening of the at least one insert within a slot of the weapon rail interface.

In another more limited aspect, at least one corner of the at least one retention clip is rounded to permit retention clip to rotate when the threaded fastener is rotated.

In another more limited aspect, at least one corner of the at least one retention clip is squared to act as a stop to prevent the retention clip from rotating when the threaded fastener is rotated.

In another more limited aspect, the apparatus further includes at least one cable extender.

In another more limited aspect, the apparatus further includes an accessory controller device electrically coupled to the at least one insert and the control module. Tthe accessory controller device includes a plurality of buttons for controlling operation of the weapons accessory device with which the at least one insert is adapted for operative coupling.

In another more limited aspect, the apparatus further includes an optics riser operatively coupled to the weapons accessory device with which the at least one insert is adapted for operative coupling and to the at least one cable.

In another more limited aspect, the apparatus further includes the handguard including the weapons rail interface and having a plurality of slots adapted to receive a weapons accessory device.

In another more limited aspect, the communications interface of the processor is a wireless interface.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is an isometric view taken generally from the right side and front illustrating the receiver and barrel portions of a firearm having a data and power distribution system in accordance with an exemplary configuration applied to a weapon accessory interface thereof.

FIG. 2 is an isometric view taken generally from the left side and front illustrating the firearm components and retrofit assembly appearing in FIG. 1.

FIG. 3 is a view taken generally from above and the right side of the firearm components and retrofit assembly appearing in FIG. 1.

FIG. 4 is a partially exploded, generally right side view of the system appearing in FIG. 3, with the handguard removed for illustrative purposes.

FIG. 5 is a further exploded, generally right side view of the system appearing in FIG. 4.

FIG. 6 is an enlarged side view of an exemplary riser with embedded connector operatively coupled to an exemplary accessory device with partial cutaway illustrating an embedded connector.

FIG. 7 is an isometric view of a handguard having exemplary power and data inserts attached thereto.

FIG. 8 is an enlarged isometric view showing the manner of serially coupling multiple power and data ports or inserts.

FIG. 9 is an enlarged isometric view of the system appearing in FIG. 8 further including a cable extender.

FIG. 10 is a side view of an alternate configuration attached to a weapon accessory interface.

FIG. 11 illustrates another alternate configuration, with the weapon handguard portion removed for illustration purposes.

FIG. 12 is schematic block diagram of an exemplary configuration of the power and data distribution system in accordance with the present disclosure.

### DETAILED DESCRIPTION OF THE PREFERRED EMBODIMENT(S)

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

As used in this application, the terms “front,” “rear,” “upper,” “lower,” “upwardly,” “downwardly,” “left,” “right,” and other orientation descriptors are intended to facilitate the description of the exemplary embodiment(s) of the present invention, and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

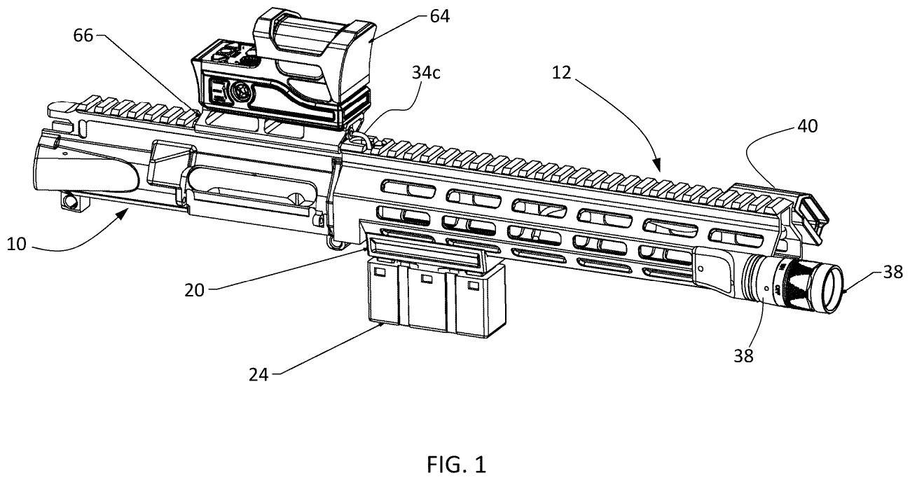

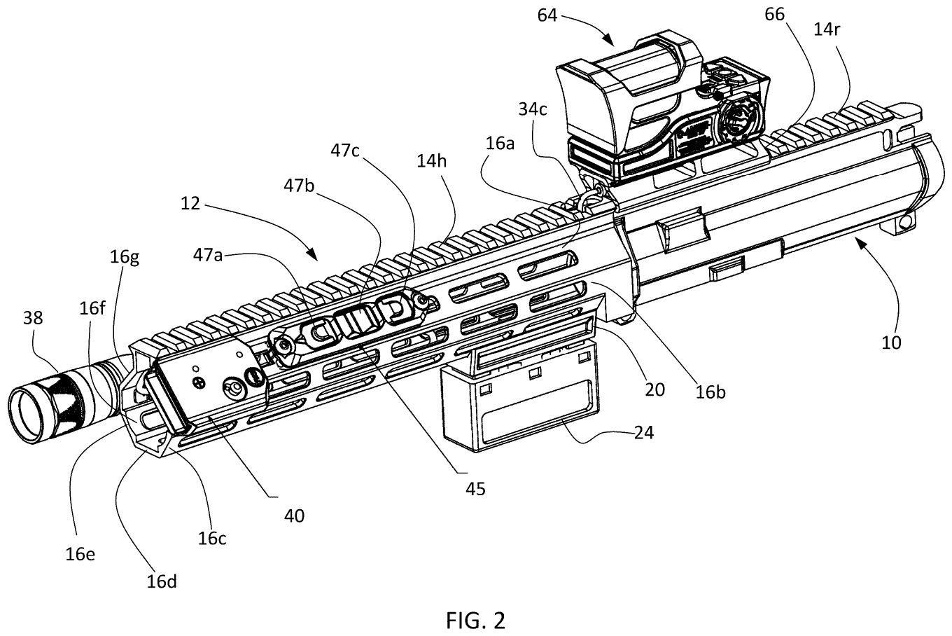

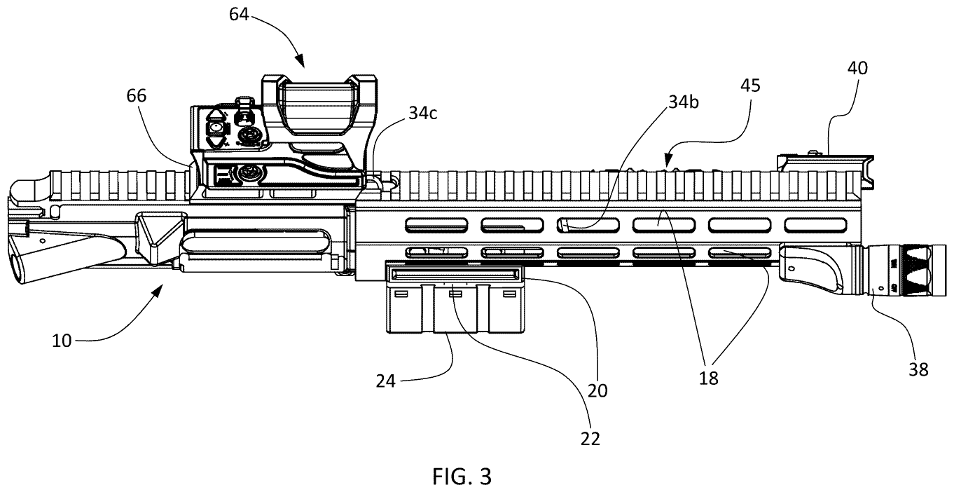

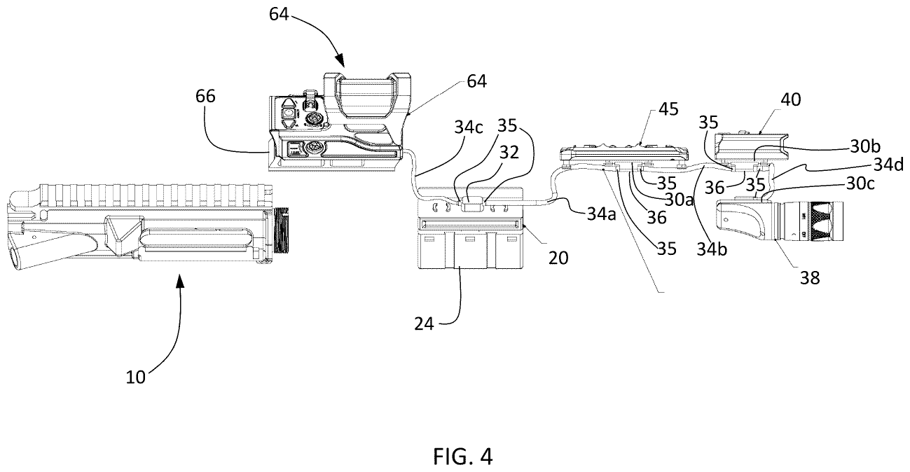

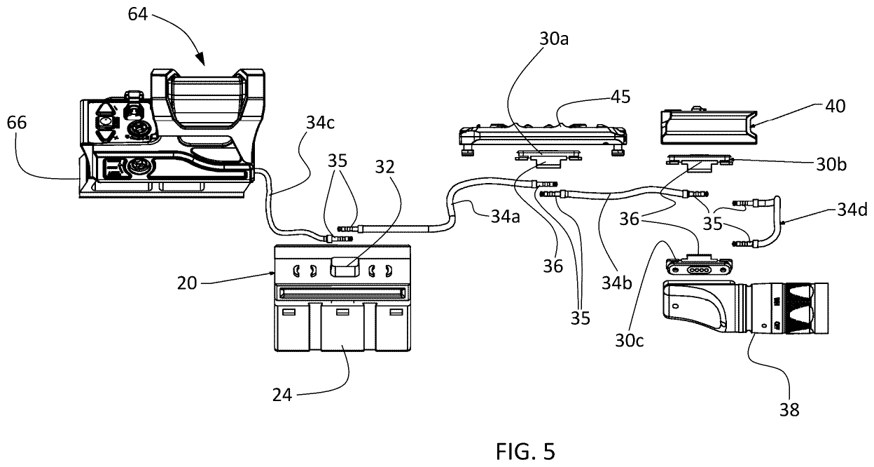

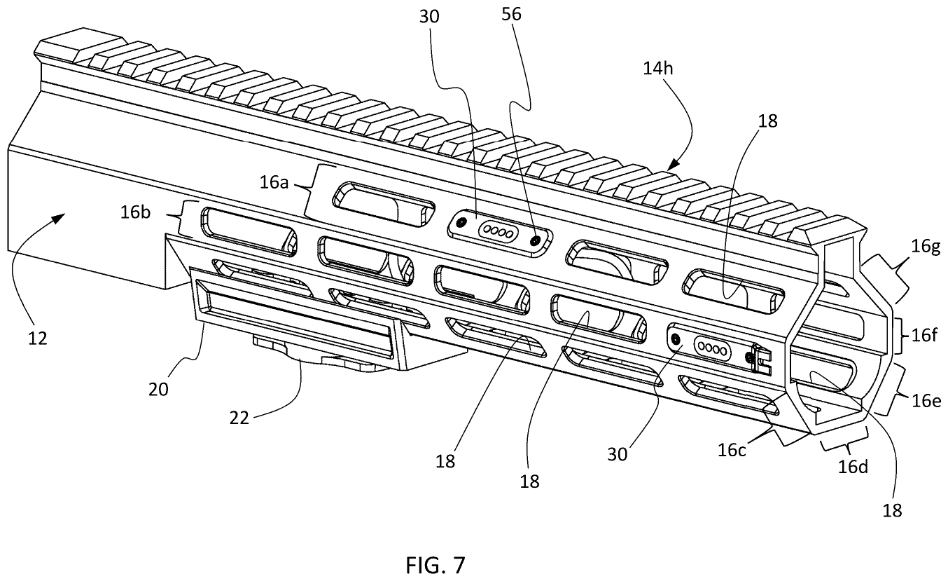

Referring now to the drawing FIGS. 1-6, there is shown an exemplary firearm receiver portion 10 having a handguard 12 attached thereto. The receiver 10 includes a Picatinny rail interface section 14r (e.g., MIL-STD-1913 or STANAG 4694). An exemplary handguard 12 appears in FIG. 7. The handguard 12 includes an upper Picatinny rail interface portion 14h and one or more slot rail portions 16a-16g for mounting one or more accessories to the weapon for increased functionality of the weapon, such as scopes, sights, lasers, rangefinders, and others. The slot rail interface portions 16a-16g may comprise an M-LOK™ (Magpul Industries Corp., Austin, TX) compatible mounting interface or similar system.

Each slot rail portion 16a-16g includes a series of apertures or slots 18 which are configured to receive an M-LOK or similar accessory or fastener. In the illustrated embodiment, a computer or control module 20 is attached to the slot rail section 16d via the slots 18 thereon. The control module 20 includes a battery interface 22 for operably connecting a power supply 24. In the illustrated embodiment, the battery interface 22 is a bayonet style interface configured to attach a Small Tactical Universal Battery (STUB) type rechargeable battery pack 24. The control module 20 includes a processor and wireless interface for management of data communications with one or more power and data ports or inserts 30 as will be described in greater detail below. The position of the arrangement of the control module 20 and the power and data ports can be selected by the user to form a custom configuration of data and power ports, e.g., in accordance with the functionality desired by the user.

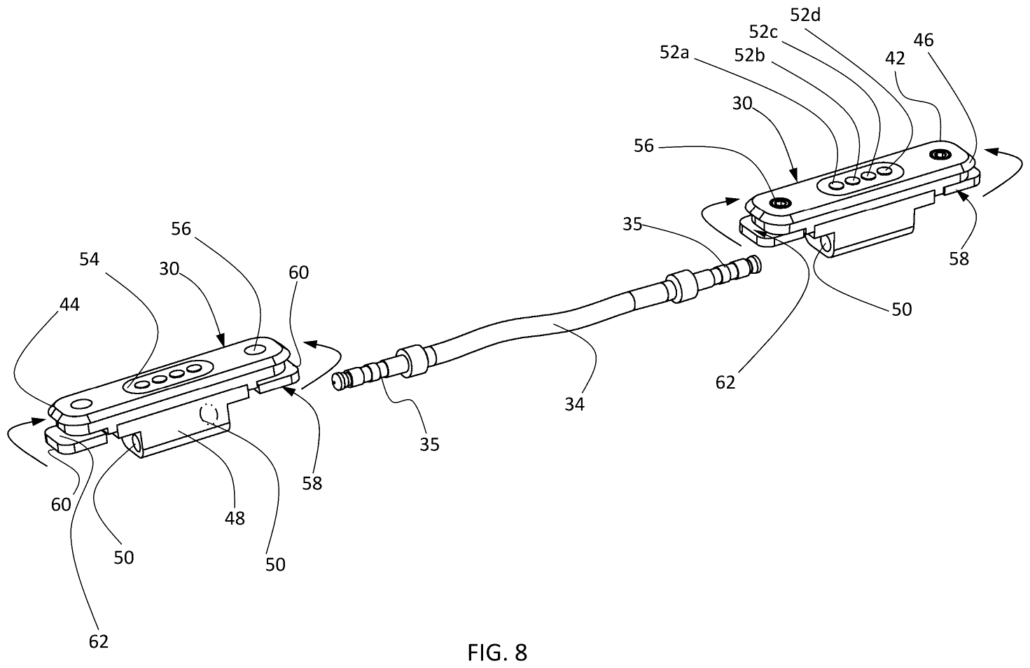

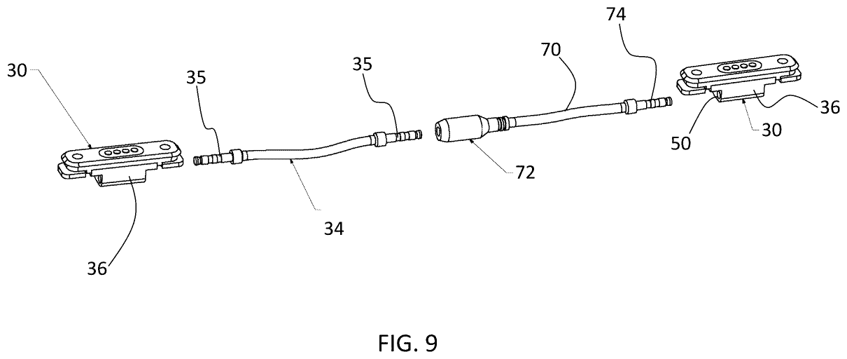

The control module 20 is secured via a slot 18 and includes a control module connector element 32 which extends through the slot 18 into the interior of the handguard 12. The control module connector element 32 is coupled to a cable 34a. The cable 34a in turn is coupled to an insert connector element 36 on an insert 30. The insert connector element 36, in turn, is coupled to another cable 34b. The cables 34a, 34b include connector ends 35 which engage connector receptacles, such as receptacles 50 on the inserts 30, and like receptacles on the controller 20, and the accessory device 64, flashlight 38, laser package 40, keypad controller 45, and so forth. The cable 34b, in turn, is coupled to an accessory device, such as a flashlight 38 or laser package 40. In embodiments, the laser package 40 is a weapon laser accessory for targeting which integrates a plurality of laser emitters, such as visible and infrared aiming lasers, an IR illumination laser, etc., which are coaligned within a single housing. It will be recognized that the illustrated configuration is exemplary only and that any number of additional or alternative devices may be employed and any number of additional inserts 30 can be serially connected as shown in FIGS. 8 and 9.

As best seen in FIGS. 8 and 9, each insert 30 includes a housing 42 having an upper peripheral flange 44. In embodiments, the peripheral flange 44 has a beveled edge 46 which provides smoother profile, thereby reducing snagging potential and improving ergonomics and comfort when handling and manipulating the weapon. The housing 42 is attached to the connector element 48 which includes cable connectors 50 for cable connection to the controller 20 and/or an adjacent insert 30 in the chain. Electrical contacts 52a-52d are potted within an electrical insulator block 54 and electrically coupled to the connectors 50 for transmitting power and data signals.

In embodiments, the contact 52a is a ground (GND) pad used as a reference point for electrical potential and common return path for the circuit. In operation, the contact 52a is electrically coupled to the ground (e.g., negative) terminal of the power supply 24. In embodiments, the contact pads 52b and 52c are coupled to data plus (D+) and data minus (D−) data lines, respectively, which carry the positive and negative signals respectively, for transmitting data between devices in accordance with a digital communication protocol. The digital communication protocol and corresponding connectors may be adapted to accommodate any communication protocol that is suitable for low speed data communication. This includes, without limitation, various protocols such as Universal Serial Bus (USB), Controller Area Network (CAN), General Purpose Input/Output (GPIO), Serial Peripheral Interface (SPI), Inter-Integrated Circuit (I2C), Universal Asynchronous Receiver-Transmitter (UART), Modbus, and Apple Lightning. In embodiments, the contact 52d is a voltage common collector (VCC) contact which is electrically coupled to the power supply voltage (e.g., positive) terminal of the power supply 24.

Threaded fasteners 56 engage rotatable retention clips 58 which are rotatable in the direction of the arrows appearing in FIG. 8. The retention clips 58 include an extending tab portion 60 which cooperate with the peripheral flange 44 to define a channel 62 at each end. Rotation of the fastener 56 allows for selectively tightening/clamping and loosening/unclamping the insert within a slot 18. Certain corners of the retention clips 58 can be selectively radiused or rounded to permit the clips 58 to rotate when the threaded fasteners 56 are rotated and other corners may be squared to act as stops to prevent rotation of the clips 58 when the threaded fasteners 56 are rotated, i.e., depending on the direction of rotation and current position of the clips 58. Accessory devices can be electrically coupled to the connector elements on the insert and mechanically secured to the slot rail interface using one or more adjacent slots on the slot rail interface.

In FIG. 8, there appears an embodiment where a relatively short cable 34 is provided to provide a serial connection between inserts 30 to be utilized between adjacent devices in the serial chain where the inserts are placed in relatively close proximity on the firearm. Referring now to FIG. 9, there is shown a further embodiment wherein a cable extender 70 (e.g., a male-female cable extender) includes a socket connector end 72 configured to receive a connector end 35 of the cable 34 and a plug connector end 74 configured to be received within a socket connector 50 the connector element 36 of an adjacent rail insert 30. The cable extender 70 allows the positioning of serially adjacent components relatively apart on the weapon, providing flexibility in configuring the user's setup. In alternative embodiments, the cable extender 70 could be replaced with a barrel connector (socket to socket) for coupling two like connection cables 34.

In the embodiments of FIGS. 1-5, an accessory controller device such as a keypad controller 45 is electrically coupled to an insert 30 which, in turn, couples the keypad controller 45 to the controller system 20. In the illustrated embodiment, the keypad controller 45 comprises a plurality of buttons or keys 47a, 47b, 47c for controlling operation of an attached accessory device such as the flashlight 38 and laser package 40.

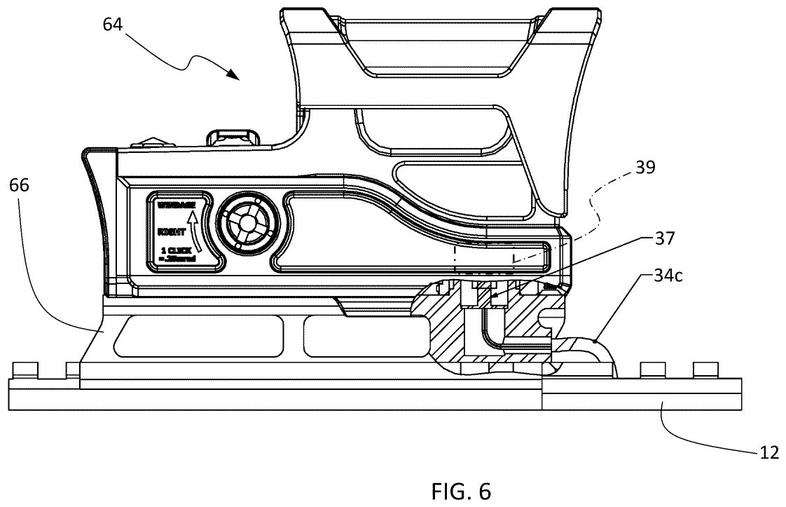

In certain embodiments, as illustrated, an optics riser 66 may be provided between the rail section 14h, 14r, as necessary, to raise the height of the device 64 to a suitable height. In the embodiment illustrated in FIGS. 1-4, a cable 34c has a proximal end electrically coupled to a connector the optics riser 66. The optics riser 66, in turn is operatively coupled to the accessory device 64 via an embedded connector. The accessory device 64 may be a sight, fire control system, or the like. As best seen in FIG. 6, which illustrates an exemplary embodiment, the proximal end of the cable 34c includes a connector element 37 embedded within the riser 66 which detachably engages a complementary connector element 39 on the accessory device 64. In embodiments, the proximal end of the cable 34c is nondetachable or hardwired to the connector element 37 and the riser 66. Alternatively, the proximal end of the cable 34c includes a plug which is detachable from the connector element 37.

The opposite end of the cable 34c includes a plug 35 engaging a complementary first connector socket 50 on the connector element 32 on the control system 20. A cable 34a includes a plug 35 engaging a second electrical connector socket 50 on the connector element 32. The opposite end of the cable 34a includes a plug 35 engaging a first connector socket 50 on a connector element 36 on an insert 30a. A control keypad 45, in turn, is operatively coupled to the insert 30a. Another cable 34b includes a plug 35 engaging a second electrical connector socket 50 on the connector element 36 of the insert 30a. The opposite end of the cable 34b includes a plug 35 engaging a first connector socket 50 on a connector element 36 on an insert 30b. A laser module 40, in turn, is operatively coupled to the insert 30b. A cable 34d includes a plug 35 engaging a second electrical connector socket 50 on the connector element 36 of the insert 30b. The opposite end of the cable 34d includes a plug 35 engaging a first connector socket 50 on a connector element 36 on an insert 30c. A flashlight module 38, in turn, is operatively coupled to the insert 30c. A second connector socket 50 on the connector element 36 of the insert 30c is available to connect further devices in serial fashion.

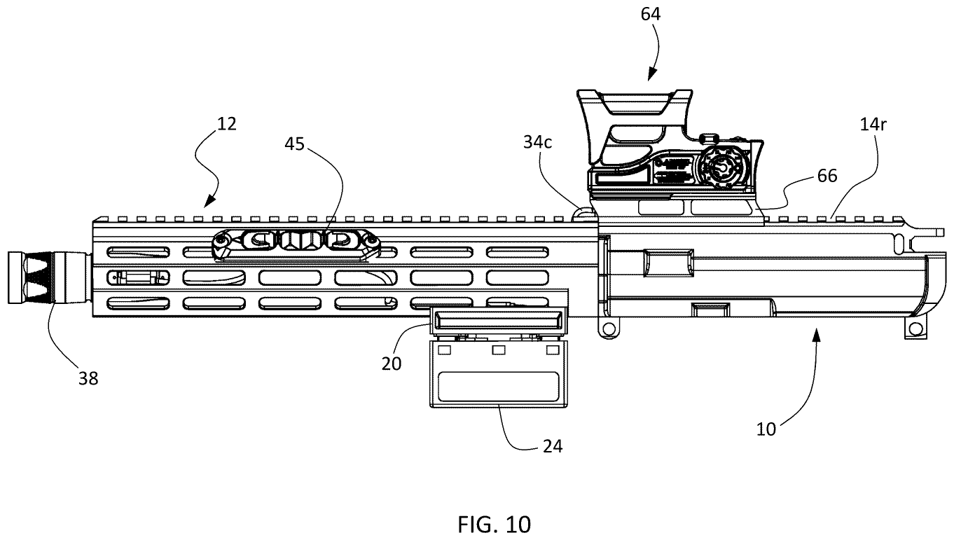

Referring now to FIG. 10, there appears a system which includes an optics riser 66 having an accessory device 64 disposed on a Picatinny accessory rail portion 14r of a firearm receiver 10 and a controller 20 with battery 24, keypad controller 45, and flashlight accessory 38 attached to a slot rail handguard portion 12. The controller 20 includes a slot rail interface connector for connection to the handguard 12. The keypad controller 45 and flashlight 38 are coupled to the slot rail handguard 12 via rail inserts 30 as described above.

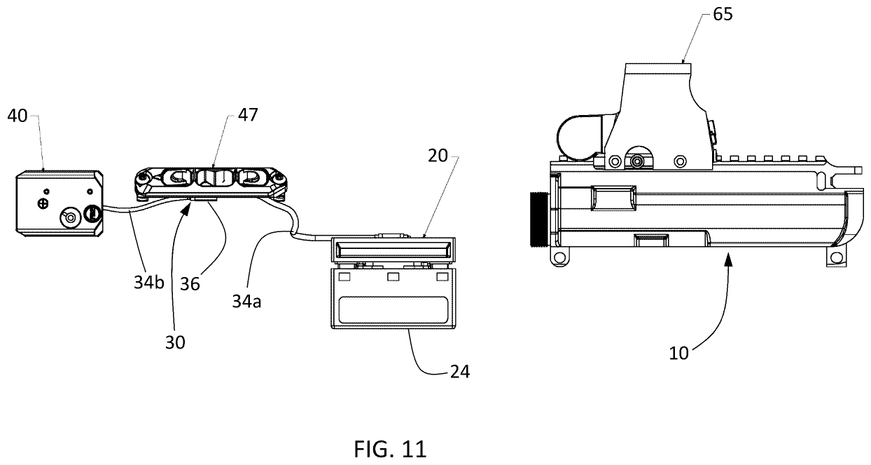

Referring now to FIG. 11, there appears a configuration that is similar to the configuration appearing in FIG. 10, but with the slot rail handguard removed for ease of exposition. The configuration in FIG. 11 is as described above by way of reference to FIG. 10, except that in FIG. 11, the riser 66 is removed and the accessory device 64 has been replaced with an alternative optical accessory 65 which is not coupled to the controller system 20. In addition, the flashlight module 38 appearing in FIG. 10 has been removed and the laser module 40 has been added to the configuration shown in FIG. 11.

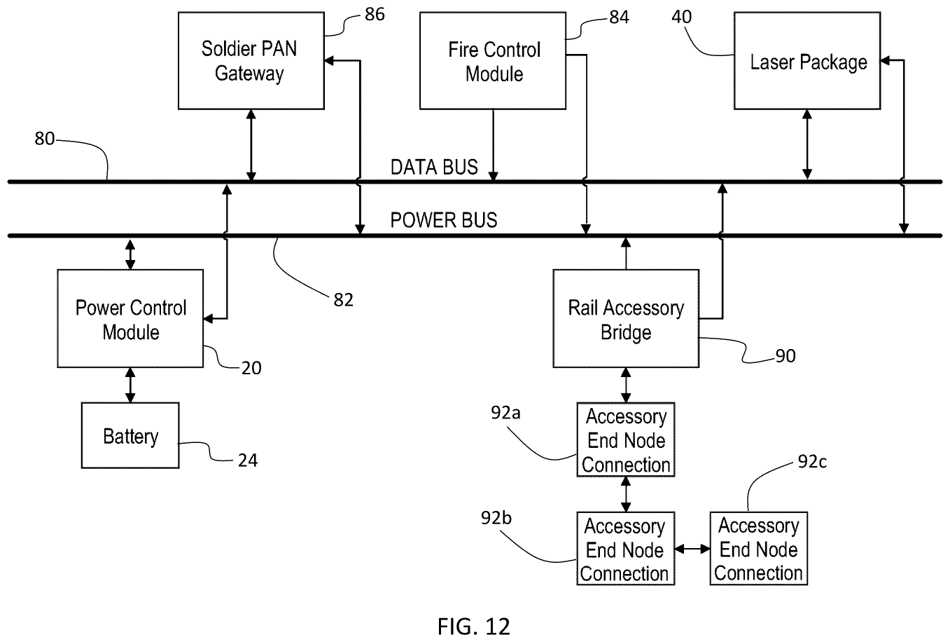

Referring now to FIG. 12, there is shown a block diagram on an exemplary modular power and data distribution system herein. The system combines power and data on a weapon system that is scalable. The weapon system can be powered by battery 24 or wired connection. In embodiments, voltage and available current can be scaled up or down based on requests over a data bus 80. In embodiments, the data bus comprises a full duplex, copper-based interface that allows subsystems to communicate over the weapon-based network system.

Accessories connect to the weapon interface with a common power bus 82 and data bus 80. In embodiments, the power bus 82 is a bidirectional power bus that can sink and source current for the weapon platform. The power bus 82 interfaces with the power control module 20 as well as additional nodes on the power bus.

Accessories can include, without limitation, laser packages 40, optical detection systems, visual augmentation systems, fire control modules 84, as well as human-machine interfaces. In embodiments, attached devices can use bridges to convert power and data to acceptable common protocols for interface with other networked connections on the power and data buses 82, 80. In embodiments, the modular power and data distribution system herein is configured to use wireless bridges between a personal area network (PAN) and other soldier interface systems such as body worn appliances, head borne appliances, and so forth.

In embodiments, the power control module 20 comprises a modular sub-component that allows bidirectional source and sink capabilities with scalable voltage and current. In certain embodiments, the power control module 20 is configured to interface with batteries 24, hardwired power sources, and wireless power transmission to ensure a stable weapon power bus. In embodiments where multiple power sources are available, the power sources are switchable via the integrated power bus 82. In embodiments where multiple power sources are available, the battery 24 may be charged via the integrated power bus 82.

In embodiments, a soldier PAN gateway 86 provides an interface to wired and wireless inter soldier networks. In embodiments, the soldier PAN gateway 86 is configured to operably interface with head borne data links, body worn data links, vehicle data links, and others.

In embodiments, a fire control module 84 includes processing electronics configured to calculate laser drive parameters, provide signaling and sensor suite information to drive data for reticle or aim point display, ballistic solutions, laser communications, human-machine interfaces, power control, and data processing from external sources.

The laser package 40 provides real time laser drive capabilities as well as monitoring sensors. In embodiments, laser outputs can be mixed wavelength and specific to usage.

A rail accessory bridge 90 provides data and power bridge at rail junction points to support varying accessory end nodes. In embodiments, the rail accessory bridge 90 uses protocol conversion to enable dissimilar end nodes to communicate on the same network data bus 80.

Accessory end nodes 92a-92c, and which may include up to any number N of accessories comprise human-machine interfaces such as keypads, buttons, joysticks, sensors, displays, flashlights, and camera-based systems.

The elements described and depicted herein, including in flow charts and block diagrams in the drawing figures, imply logical boundaries between the elements. However, according to software or hardware engineering practices, the depicted elements and the functions thereof may be implemented in a computer-based information handling system having one or more processors capable of executing program instructions stored thereon or in a memory operably associated therewith. Furthermore, the elements depicted in the flow chart and block diagrams or any other logical component may be implemented on a machine capable of executing program instructions. Thus, while the foregoing drawings and descriptions set forth functional aspects of the disclosed system, no particular arrangement of software for implementing these functional aspects should be inferred from these descriptions unless explicitly stated or otherwise clear from the context. Program instructions may be realized in hardware, software, firmware, or any combination of hardware, software, and/or firmware suitable for a particular application. The hardware may include a general-purpose computer, dedicated or specific computing device, or a particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The invention has been described with reference to the preferred embodiments. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. An apparatus for providing electrical power to and communicating data and control signals among weapon accessory devices disposed on a handguard having a weapon rail interface and a plurality of slots, the apparatus comprising:
a control module attachable to the handguard via at least one of the plurality of slots of the handguard, the control module comprising:
a processor;
a power supply operably coupled to the processor; and
a control module connector element adapted to extend through the at least one of the plurality of slots via which the control module is attachable to the weapon rail interface;
at least one insert comprising an insert connector element, the at least one insert adapted for operative coupling with a weapons accessory device, wherein the processor of the control module comprises a communications interface for data communication with the at least one insert; and
at least one cable comprising connector ends on either end of the at least one cable, wherein the connector ends are adapted to couple to at least the control module connector element of the control module and the insert connector element of the at least one insert.

2. The apparatus of claim 1, wherein the control module further comprises a power interface for operably connecting the power supply of the control module.

3. The apparatus of claim 1, wherein:
the at least one cable comprises at least two cables;
the connector ends are further adapted to couple to the weapons accessory device; and
the operative coupling of the at least one insert with the weapons accessory device is via one of the at least two cables.

4. The apparatus of claim 1, wherein the weapons accessory device with which the at least one insert is adapted for operative coupling is selected from the group consisting of a flashlight, a laser package, an optical sight, and a fire control system.

5. The apparatus of claim 1, further comprising at least one of the weapons accessory device with which the at least one insert is adapted for operative coupling, wherein the at least one weapons accessory device is one or more selected from the group consisting of a flashlight, a laser package, an optical sight, and a fire control system.

6. The apparatus of claim 1, wherein the control module connector element comprises connector receptacles that engage with the connector ends of the at least one cable.

7. The apparatus of claim 1, wherein the insert connector element comprises connector receptacles that engage with the connector ends of the at least one cable.

8. The apparatus of claim 7, wherein the at least one insert further comprises a housing attached to the insert connector element with at least one electrical contact electrically coupled to connector receptacles for transmitting power and data signals.

9. The apparatus of claim 8, wherein the at least one electrical contact is four electrical contacts, a first of which is electrically coupled to the ground/negative terminal of the power supply; a second of which is electrically coupled to a data line that carries positive signals for transmitting data between devices; a third of which is electrically coupled to a data line that carries negative signals for transmitting data between devices; and a fourth of which is electrically coupled to the voltage/positive terminal of the power supply.

10. The apparatus of claim 8, wherein the housing has at least one upper peripheral flange.

11. The apparatus of claim 10, wherein the at least one upper peripheral flange has a beveled edge.

12. The apparatus of claim 10, wherein:
the at least one insert further comprises at least one retention clip with an extending tab portion and a threaded fastener around which the at least one retention clip is rotatable;
a channel is defined between the at least one upper peripheral flange and the extending tab portion of the at least one retention clip; and
rotation of the retention clip around the threaded fastener allows for tightening and loosening of the at least one insert within a slot of the weapon rail interface.

13. The apparatus of claim 12, wherein at least one corner of the at least one retention clip is rounded to permit retention clip to rotate when the threaded fastener is rotated.

14. The apparatus of claim 12, wherein at least one corner of the at least one retention clip is squared to act as a stop to prevent the retention clip from rotating when the threaded fastener is rotated.

15. The apparatus of claim 12, further comprising at least one cable extender.

16. The apparatus of claim 1, further comprising an accessory controller device electrically coupled to the at least one insert and the control module, wherein the accessory controller device comprises a plurality of buttons for controlling operation of the weapons accessory device with which the at least one insert is adapted for operative coupling.

17. The apparatus of claim 1, further comprising an optics riser operatively coupled to the weapons accessory device with which the at least one insert is adapted for operative coupling and to the at least one cable.

18. The apparatus of claim 1, further comprising the handguard comprising the weapons rail interface and having a plurality of slots adapted to receive a weapons accessory device.

19. The apparatus of claim 1, wherein the communications interface of the processor is a wireless interface.
